(19) United States
(12) Patent Application Publication
(10) Pub. No.: US 2026/0203380 A1
(43) Pub. Date: Jul. 16, 2026

(54) RESTRICTING PRIVACY POLICY BASED NON-COMPLIANT USER INPUT FIELDS FOR APPLICATIONS

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 19/017,319

(22) Filed: Jan. 10, 2025

(51) Int. Cl. G06F 21/12; G06F 21/62

(52) U.S. Cl. CPC G06F 21/128; G06F 21/62

(57) ABSTRACT

An electronic device provides techniques for monitoring and enforcing data privacy policies for applications executed by the electronic device. The electronic device includes a memory having application(s) and a privacy policy settings corresponding to the application(s). The electronic device includes a communications subsystem that links the electronic device to a network entity associated with a first application. A processor is communicatively coupled to the memory and the communications subsystem. In response to detecting an action by the first application to transmit selected data via the communications subsystem to the network entity, the processor is configured to cause the electronic device to identify a privacy policy applicable to the data, based on the privacy policy settings. In response to determining that transmitting the data would violate the privacy policy, the processor is configured to cause the electronic device to at least partially block a transmission of the data.

### BACKGROUND

### 1. Technical Field

The present disclosure relates generally to electronic devices, and more particularly to electronic devices that receive, process, and collect user data for transmission to a network entity.

### 2. Description of the Related Art

Electronic devices such as smartphones, tables, laptops, and desktop workstations are operated by users for a myriad of functions such as office automation, communication and entertainment. The electronic devices are readily configurable to perform a wide number of functions by installing and executing applications that support one or more of these functions. Users of electronic devices often enter personal private data into the electronic device for processing by particular applications to achieve a desired function.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 illustrates a block diagram representation of a privacy policy compliance supervision module of the electronic device configured to detect noncompliance and enforce compliance with a privacy policy by an application executing on the electronic device, according to one or more embodiments;

FIG. 3 illustrates the electronic device operating at different times in two locations subject to different privacy policy laws, according to one or more embodiments;

FIG. 4 illustrates a display of the electronic device presenting a user profile interface window that includes questions that are not compliant with an established privacy policy and includes enforcement responses to the questions, according to one or more embodiments;

FIG. 5 is a flow diagram presenting a computer-implemented method for detecting and preventing transmission of data by an electronic device that would violate a privacy policy, according to one or more embodiments;

FIG. 6 is a flow diagram presenting a computer-implemented method for determining application privacy policy settings consented to by a user an electronic device during an application setup or update, according to one or more embodiments; and

FIG. 7 is a flow diagram presenting a computer-implemented method for determining privacy policy settings applicable to an application based on a geographic location of the electronic device, according to one or more embodiments.

### DETAILED DESCRIPTION

According to aspects of the present disclosure, an electronic device, a method, and a computer program provide various techniques for monitoring and enforcing data privacy policies for applications executed by the electronic device. In today's digital age, privacy has emerged as a paramount concern. With the exponential growth of technology, the collection, storage, and utilization of personal data have become intrinsic to businesses across industries. This data serves as the lifeblood, enabling targeted marketing, personalized services, and improved user experiences. However, amidst this data-driven landscape, the need for safeguarding individual privacy rights has gained unprecedented significance. Users may be inconvenienced, embarrassed, or be financially or professionally compromised by breaches of data privacy. The discourse around privacy has escalated, prompting widespread awareness about data rights and the importance of transparency in handling user information. Privacy policies, often lengthy and intricate, have become a norm, accompanying every application or service, delineating the terms of data usage and sharing. Users' responses to these policies vary -- some users meticulously scrutinize, exercising selective opt-ins, while others readily agree without perusing the specifics. This dichotomy underscores the evolving relationship between individuals, their private data, and the digital platforms the individuals engage with. As data continues to fuel innovation and business strategies, the balance between data-driven progress and user privacy remains a critical focal point in contemporary discussions.

The present disclosure contemplates and addresses the problem that arises when privacy policies are drafted by businesses and accepted by users, but the policies are not accurately implemented in applications. This noncompliance results in unintended data collection or usage that diverges from what was outlined and agreed upon. Users' data are captured without their awareness or consent, despite the specific data practices that were agreed to. This breach of trust leaves users vulnerable to privacy violations, such as targeted advertising, identity theft, or other forms of misuse. Ensuring that privacy policies are faithfully implemented is essential to safeguarding users' sensitive information and fostering a secure digital environment, where individuals feel respected and empowered. –In some instances, application consent to collect specific data via privacy policy may not be the same as device-level consent via permission of various hardware and software information such as android permissions. In an example, the user may have differing levels of confidence in the entity that may receive data from the application as versus an original equipment manufacturer, distributor, or communication carrier.

In one or more embodiments of the present disclosure, the electronic device detects that a privacy policy is being presented for acceptance via a user interface. The electronic device extracts and summarizes the contents of the privacy policy. The electronic device monitors the subsequent usage of the first application. The electronic device evaluates collection of user data and monitors for the collection of unauthorized data (i.e., data not compliant with the privacy policy). In response to determining that unauthorized data is being collected, the electronic device prevents the collection of the unauthorized data.

In one or more embodiments, the present disclosure provides techniques of supervising and enforcing privacy policy based at least in part on identifying non-compliant user input fields for applications that solicit restricted user data. The electronic device detects when a privacy policy of a first application is being accepted for the first time on the electronic device, such as detecting that the privacy policy is being rendered during an application setup flow. The electronic devices analyze the privacy policy by using artificial intelligence (AI) techniques, to detect: (i) the type of data collected; (ii) how the data is to be collected; (iii) how the data is to be used; and (iv) how long the data will be stored. The electronic device analyzes information about any user activity tracking for third-party service providers such as for analytical or marketing tools. The electronic device extracts and summarizes the contents of the new application’s privacy policy. In an example, at a device level, the electronic device provides platform access to what actions each application is taking in soliciting, processing, collecting, and transmitting restricted data. In another example, the electronic device provides monitoring of each output presented to a user and each input provided by the user to detect user actions that indicate consent or not to privacy policies. With the agreed-upon privacy policy determined, the electronic device monitors the usage of the first application: (i) through monitoring the user interactions with the application, such as via a device display screen; and (ii) through interception of the communications from the application to a server. The electronic device determines whether a current collection of data is beyond (i.e., not in compliance with) the allowed data usage accepted in the privacy policy. The electronic device prevents unauthorized/restricted data from being collected. In an example, the electronic device automatically suppresses/alters the communications to server to remove or prevent unauthorized data collection and/or transmission. In another example, the electronic device masks the data inputs or collection of the unauthorized data, such as by replacing restricted data with generic unrestricted data (e.g., replacing the restricted data with “value is redacted” or “#######”). In an additional example, the electronic device alerts/warns the user of unauthorized data collection to prompt a manual action by the user to the noncompliance. In one or more embodiments, the electronic device updates the extracted privacy policy contents periodically based on any changes to the accepted privacy policy.

According to one or more embodiments, an electronic device has a memory including (i) one or more applications that includes a first application; and (ii) a privacy policy settings corresponding to the one or more applications. The electronic device includes a communications subsystem that links the electronic device to a network entity associated with the first application. A processor of the electronic device is communicatively coupled to the memory and the communications subsystem. In response to detecting an action by the first application to transmit selected data via the communications subsystem to the network entity, the processor is configured to cause the electronic device to identify a privacy policy applicable to the data, based on the privacy policy settings. In response to determining that transmitting the data would violate the privacy policy, the processor is configured to cause the electronic device to at least partially block a transmission of the data.

According to one or more embodiments, a computer-implemented method is provided for monitoring and enforcing data privacy policies for applications executed by the electronic device. In response to detecting an action by a first application to transmit selected data via a communications subsystem of an electronic device to a network entity, the method includes identifying a privacy policy applicable to the data, based on privacy policy settings. In response to determining that transmitting the data would violate the privacy policy, the method includes at least partially blocking a transmission of the data.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

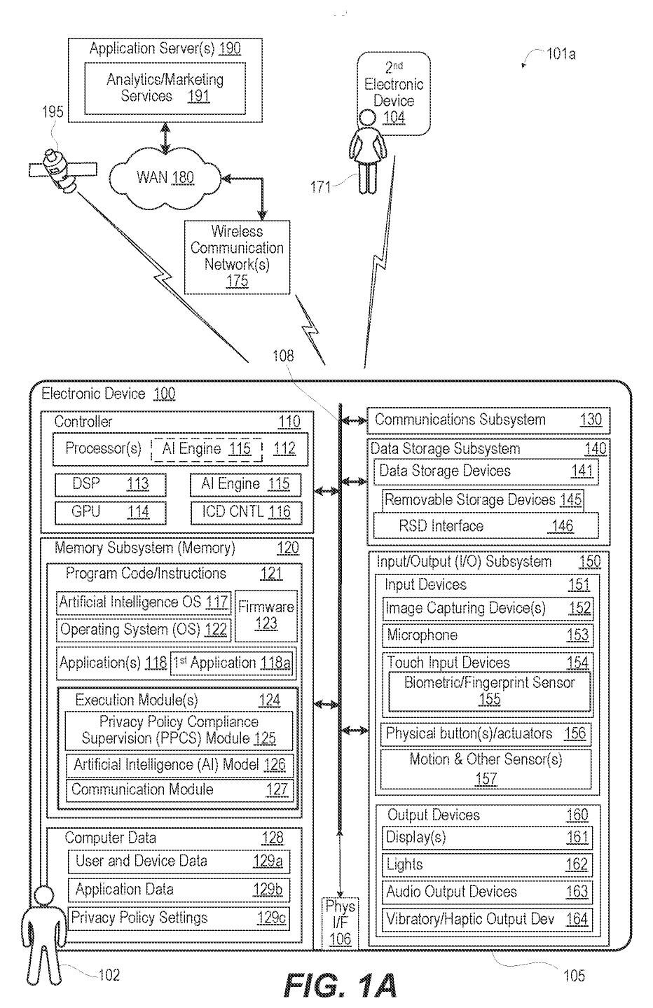

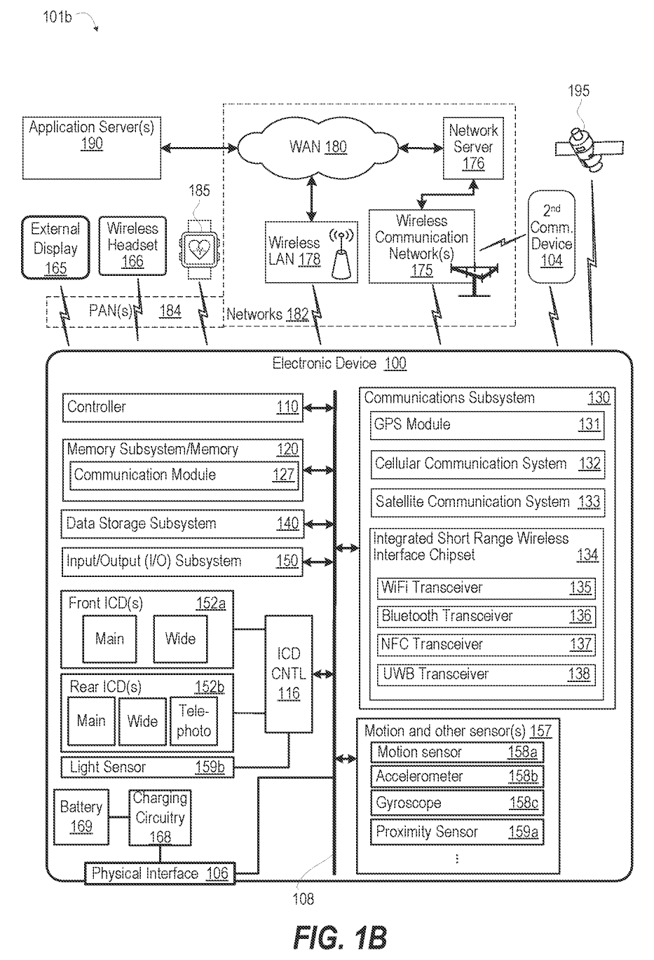

Those of ordinary skill in the art will appreciate that the hardware components and basic configuration depicted in the following figures may vary. For example, the illustrative components within electronic device 100 (FIGS. 1A – 1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100 monitors execution of applications 118, including first application 118a, for collections of data that are not compliant with privacy policies and enforces the privacy policies. In one or more embodiments, electronic device 100 detects establishment of the privacy policies, consented to by user 102 of electronic device 100, capturing the privacy policy settings as agreed upon. Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

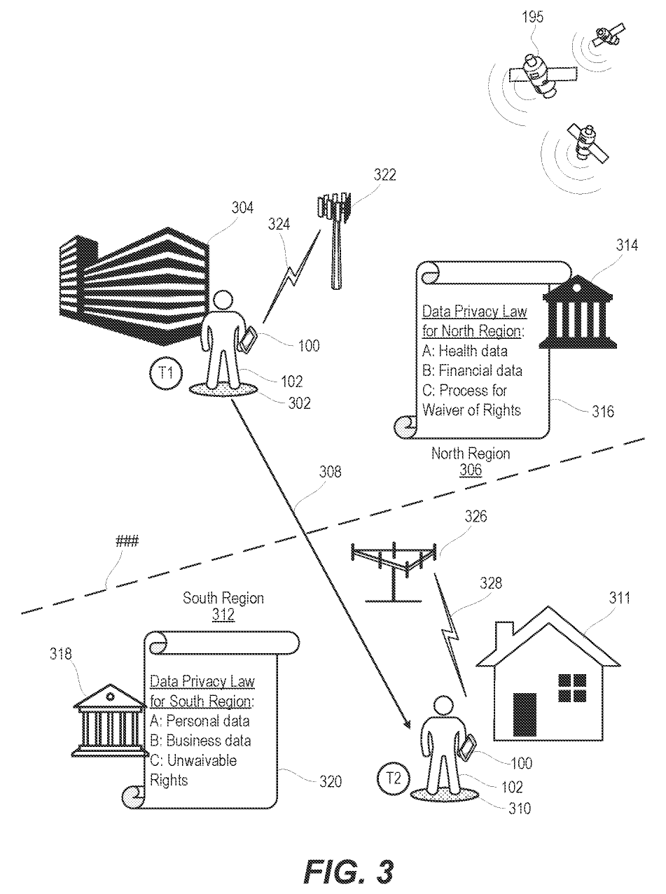

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122 . Operating system 122 may include or be augmented by device AI operating system (OS) 117 that is described below with regard to FIG. 3.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, privacy policy compliance supervisory (PPCS) module 125, which provides the features and operating functionality of the disclosed embodiments when the corresponding program instructions of PPCS module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within PPCS module 125 and is trained to support the AI features of PPCS module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, PPCS module 125 can include program instructions that cause or configure processor 112 to cause electronic device 100 to curate push notifications based on analyzing proposed content for user interest(s). Other features provided by PPCS module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of PPCS module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user’s tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency (RF) front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of PPCS module 125 and/or access to other applications, online transactions, and resources. Application servers 190 may host analytics/marketing services 191 that support applications 118.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

With particular reference to FIG. 1A, according to aspects of the present disclosure, electronic device 100 has memory 120 including (i) one or more applications 118 including first application 118a; and (ii) privacy policy settings 129c corresponding to one or more applications 118. Electronic device 100 includes communications subsystem 130 that links electronic device 100 to a network entity (e.g., application server(s) 190) associated with first application 118a. P processor 112 of electronic device 100 is communicatively coupled to memory 120 and communications subsystem 130. In response to detecting an action by the first application to transmit selected data via the communications subsystem to the network entity, processor 112 is configured to cause electronic device 100 to identify a privacy policy applicable to the data, based on privacy policy settings 129c. In response to determining that transmitting the data would violate the privacy policy, processor 112 is configured to cause electronic device 100 to at least partially block a transmission of the data.

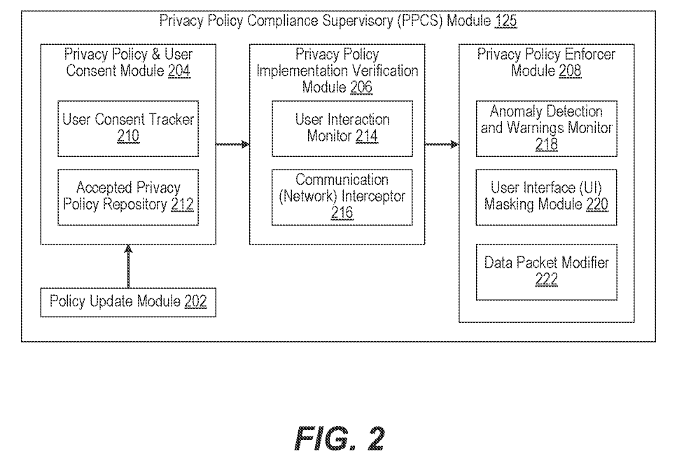

FIG. 2 illustrates a block diagram of functioning/operational components of privacy policy compliance supervisory (PPCS) module 125 of electronic device 100 (FIG. 1A) configured to detect and mitigate noncompliance with privacy policy settings. In one or more embodiments, PPCS module 125 includes policy update module 202, privacy policy and user consent module 204, privacy policy implementation verification module 206, and privacy policy enforcer module 208. Policy update module 202 receives external privacy policies and settings established, for example, by statute, regulation, communication carrier, and device manufacturer. Applications 118 (FIG. 1A) may include setup and update user interfaces that seek consent, modification, and waiver to the privacy policies and settings. Privacy policy and user consent module 204 detects instances in which applications 118 (FIG. 1A) present public policies to user 102 (FIG. 1A). User consent tracker 210 detects specific privacy policy settings that received user consent and stores the specific privacy policy settings in accepted privacy policy repository 212. During operation of applications 118 (FIG. 1A), privacy policy implementation verification (PPIV) module 206 performs application behavior analysis. PPIV module 206 refers to general (e.g., not waived or modified) and specific privacy policy settings maintained by privacy policy enforcer module 208. In an example, user interaction monitor 214 detects when operation of applications 118 (FIG. 1A) included soliciting and collecting restricted data. Communication (network) interceptor 216 detects when applications 118 (FIG. 1A) attempt to transmit restricted data. When noncompliant operation is detected, PPIV module 206 triggers privacy policy enforcer module 208. In an example, anomaly detection and warning monitor 218 may respond to a noncompliance trigger by presenting an alert to either prompt a manual intervention or approval to noncompliant use of restricted data. In another example, user interface (UI) masking module 220 may intercept attempts to solicit restricted data by rendering at least portions of a user interface inoperable for receiving restricted data. In an additional example, data packet modifier 222 may alter data to remove restricted data prior to transmission.

FIG. 3 illustrates electronic device 100 operating at different times in north location 302 at business 304 within north region 306 at first time “T1” and then moving as indicated by arrow 308 to south location 310 at second time “T2” at residence 311 within south region 312. Electronic device 100 monitors current location based on a location service such as provided by GPS signal broadcasts by GPS satellites 195. North region 306 is under the jurisdiction of north official entity 314 (e.g., legislature, regulatory body, executive agency, etc.), which has imposed first privacy policy law 316. South region 312 is under the jurisdiction of south official entity 318 (e.g., legislature, regulatory body, executive agency, etc.), which has imposed second privacy policy law 320, which may differ in whole or in part from first privacy policy law 316. In one or more embodiments, jurisdiction may be based at least in part on location of radio access technology (RAT) device (e.g., cellular or wireless base station). In an example, first base station 322 is in north region 306. Electronic device 100 communicates via first communication channel 324 while in north region 306. Second base station 326 is in south region 312. Electronic device 100 communicates via second communication channel 328 while in south region 312. In determining what privacy policy settings apply to execution of applications 118, electronic device 100 determines which overarching regional privacy policy laws currently apply to electronic device 100. In one or more embodiments, electronic device 100 may determine a pattern of movement and construct a merged set of policy policies that satisfy all regional privacy policy laws that electronic device 100 is expected to be subjected to. It is appreciated that the locations can be different local municipalities or even different countries, each having its own set of privacy laws, which are discoverable and downloaded by electronic device 100 when/while the electronic device 100 is physically located in the corresponding jurisdiction.

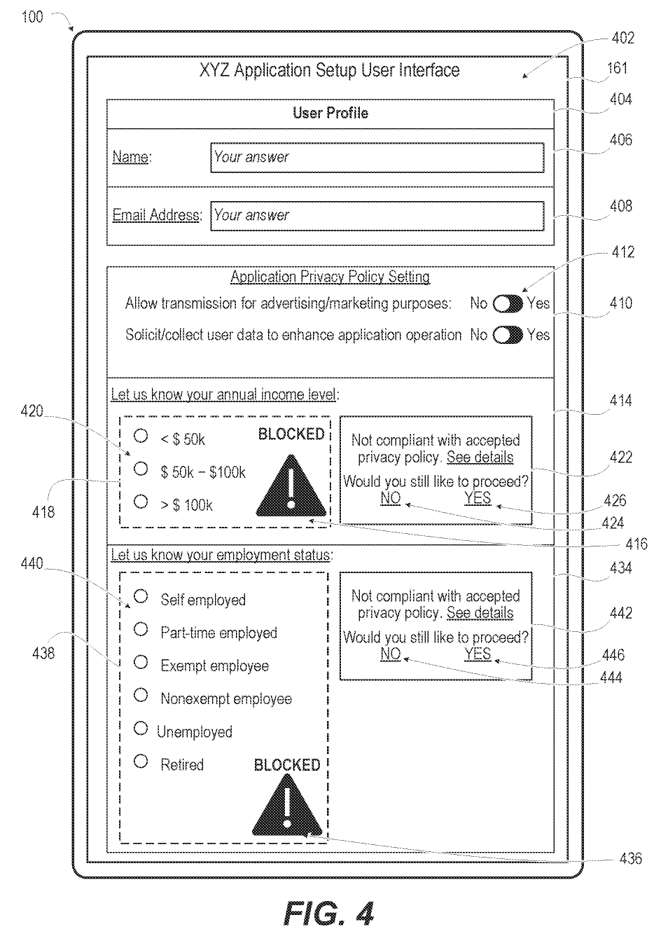

FIG. 4 illustrates display 161 of electronic device 100 presenting user profile interface window 402 that includes questions to elicit responses containing data/information that are not compliant for sharing with a privacy policy, prompting an automatic enforcement on responses to the questions. In an example, user profile window 404 solicits unrestricted questions of name segment 406 and email address segment 408. Application privacy policy setting window 410 presents privacy policy settings 412 for user consent to waiving privacy rights such as for solicitation, collection, and transmission of restricted data. Absent legitimate consent, electronic device 100 generates, renders and presents alerts to noncompliant solicitation, collection and transmission of restricted data. In an example, income segment 414 requests selection of an income range of the user. In response, alert icon 416 is presented. Blocking annotation square 418 indicates that income radio buttons 420 are inoperative. Alert box 422 presents notification that the question is not compliant with accepted privacy policy and presents nonconsent control (“No”) 424 and consent control (“Yes”) 426 to respectively maintain or waive the privacy policy setting at least in this instance. Similarly, in another example, employment segment 434 requests selection of an employment status. In response, alert icon 436 is presented. Blocking annotation square 438 indicates that income radio buttons 440 are inoperative. Alert box 442 presents notification that the question is not compliant with accepted privacy policy and presents nonconsent control (“No”) 444 and consent control (“Yes”) 446 to respectively maintain or waive the privacy policy setting at least in this instance.

Returning to FIG. 1A, in one or more embodiments, artificial intelligence (AI) engine 115 is trained to identify private data. In determining that transmitting the data would violate the privacy policy, processor 112 is configured to cause electronic device 100 to parse, using AI engine 115, the selected data to identify permitted data applicable to the privacy policy and restricted data not applicable to the privacy policy. In one or more particular embodiments, AI engine 115 is trained to identify settings and determine violations of the privacy policy based on natural language processing.

In one or more embodiments, electronic device 100 includes at least one output device 160 communicatively coupled to processor 112. In response to determining that transmitting the selected data would violate the privacy policy, processor 112 is configured to cause electronic device 100 to generate and present, via at least one output device 160, an alert indicating a violation of the privacy policy settings.

In one or more embodiments, the privacy policy includes device privacy policy settings that constrain operation of first application 118a. In one or more particular embodiments, electronic device 100 includes at least one input device 151 that is communicatively coupled to processor 112. Electronic device 100 includes at least one output device 160 that is communicatively coupled to processor 112. Processor 112 is configured to cause electronic device 100 to monitor a setup user interface window 402 (FIG. 4) generated by first application 118a and presented via at least one output device 160. Processor 112 is configured to cause electronic device 100 to determine an application privacy policy setting consented to by user 102 of electronic device 100 based on content of setup user interface window 402 (FIG. 4) and at least one user input received via at least one input device 151 to setup user interface window 402 (FIG. 4). Processor 112 is configured to cause electronic device 100 to compare the application privacy policy setting selected by user 102 with the device privacy policy settings. In response to determining that the application privacy policy setting violates the device privacy policy settings, processor 112 is configured to cause electronic device 100 to generate and present via at least one output device 160 an alert indicating a violation of device privacy policy settings. along with options to correct or modify the violation, such as described above with regard to FIG. 4.

In one or more embodiments, the privacy policy settings include regulatory privacy settings that constrain operation of first application 118a. Electronic device 100 further includes at least one output device 160 communicatively coupled to processor 112. In response to detecting the action by first application 118a to transmit the selected data via communications subsystem 130 to the network entity (e.g., application servers 190), processor 112 is configured to cause electronic device 100 to determine a geographic location of electronic device 100. Processor 112 is configured to cause electronic device 100 to identify the regulatory privacy settings associated with the geographic location and applicable to the data. In response to determining that transmitting the data would violate the regulatory privacy settings, processor 112 is configured to cause electronic device 100 to generate and present via at least one output device 160 an alert indicating a violation of the regulatory privacy setting.

In one or more embodiments, electronic device 100 further includes at least one output device 160 communicatively coupled to processor 112. In response to determining that transmitting the data would violate the privacy policy settings, processor 112 is configured to cause electronic device 100 to at least partially block the action by altering the data to remove or mask restricted portions of the selected data to avoid violating the privacy policy settings.

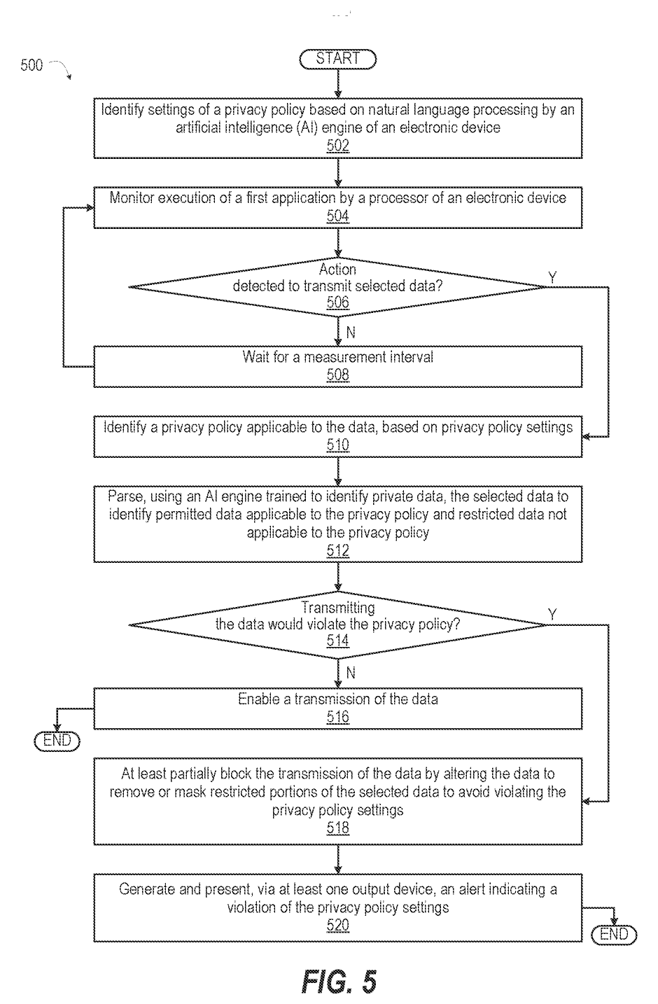

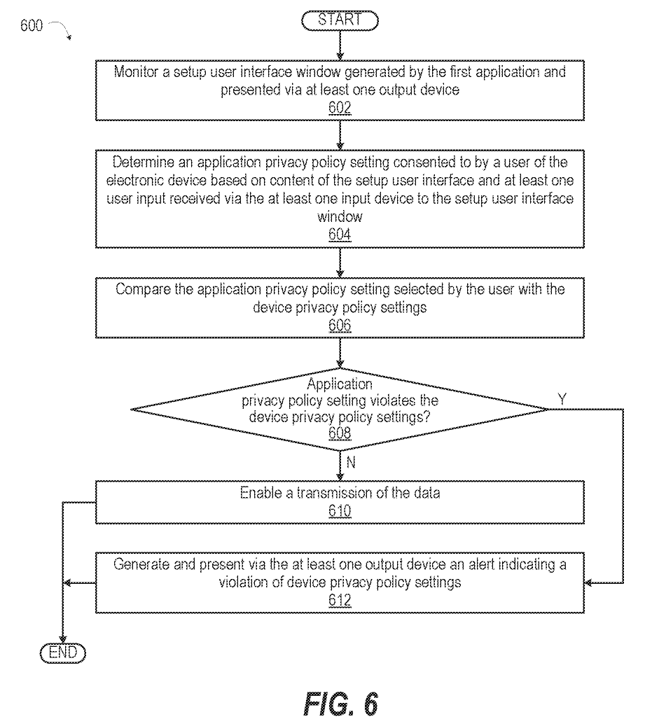

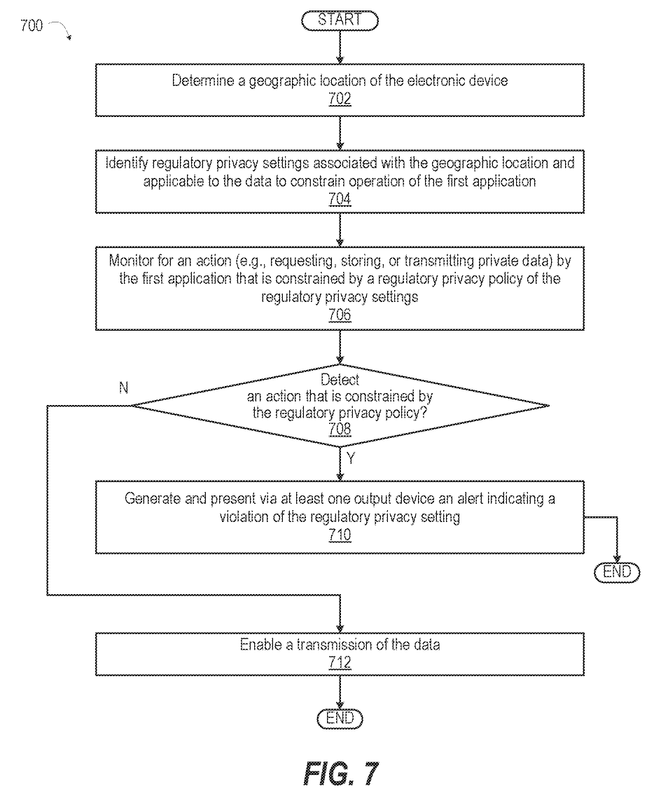

FIG. 5 is a flow diagram presenting computer-implemented method 500 for detecting and preventing transmission of data by an electronic device that would violate a privacy policy. FIG. 6 is a flow diagram presenting a computer-implemented method for determining application privacy policy settings consent to by a user of an electronic device during an application setup or update. FIG. 7 is a flow diagram presenting a computer-implemented method for determining privacy policy settings applicable to an application based on a geographic location of the electronic device. Additional features of method 600 (FIG. 6) and method 700 (FIG. 7) may augment method 500 (FIG. 5). The descriptions of method 500 (FIG. 5), method 600 (FIG. 6), and method 700 (FIG. 7) are provided with general reference to the specific components illustrated within the preceding FIGS. 1A – 1B, 2 – 4. Specific components referenced in method 500 (FIG. 5), method 600 (FIG. 6), and method 700 (FIG. 7) may be identical or similar to components of the same name used in describing preceding FIGS. 1A – 1B, 2 – 4. In one or more embodiments, controller 110 (FIG. 1A) configures electronic device 100 (FIGS. 1A – 1B) or a similar computing device to provide the described functionality of method 500 (FIG. 5), method 600 (FIG. 6), and method 700 (FIG. 7).

With reference to FIG. 5, method 500 includes identifying settings of a privacy policy based on natural language processing by an artificial intelligence (AI) engine of an electronic device (block 502). Method 500 includes monitoring execution of a first application by a processor of an electronic device (block 504). Method 500 includes determining whether an action by the first application is detected to transmit selected data via a communications subsystem of an electronic device to a network entity (decision block 506). In response to not detecting an action by a first application to transmit selected data via a communications subsystem of an electronic device to a network entity, method 500 includes waiting for a measurement interval (block 508). Then method 500 returns to block 504. In response to detecting an action by a first application to transmit selected data via a communications subsystem of an electronic device to a network entity, method 500 includes retrieving privacy policy settings and identifying a privacy policy applicable to the data, based on the privacy policy settings (block 510). Method 500 includes parsing, using an AI engine trained to identify private data, the selected data to identify permitted data applicable to the privacy policy and restricted data not applicable to the privacy policy (block 512). Method 500 includes determining, based on the parsing, whether transmitting the data would violate the privacy policy (decision block 514). In response to determining that transmitting the data would not violate the privacy policy, method 500 includes enabling a transmission of the data (block 516). Then method 500 ends. In response to determining that transmitting the data would violate the privacy policy, method 500 includes at least partially blocking the transmission of the data by altering the data to remove or mask restricted portions of the selected data to avoid violating the privacy policy settings (block 518). Method 500 includes generating and presenting, via at least one output device, an alert indicating a violation of the privacy policy settings (block 520). Then method 500 ends.

According to aspects of the present disclosure, in response to detecting an action by a first application to transmit selected data via a communications subsystem of an electronic device to a network entity, method 500 may include identifying a privacy policy applicable to the data, based on privacy policy settings. In response to determining that transmitting the data would violate the privacy policy, method 500 may include at least partially blocking a transmission of the data.

In one or more embodiments, method 500 may further include determining that transmitting the data would violate the privacy policy by parsing, using an artificial intelligence (AI) engine trained to identify private data, the selected data to identify permitted data applicable to the privacy policy and restricted data not applicable to the privacy policy. In one or more particular embodiments, the AI engine is trained to identify settings and determine violations of the privacy policy based on natural language processing. In one or more embodiments, in response to determining that transmitting the selected data would violate the privacy policy, method 500 may further include generating and presenting, via at least one output device, an alert indicating a violation of the privacy policy settings.

In one or more embodiments, the privacy policy includes device privacy policy settings that constrain operation of the first application. In one or more particular embodiments, method 500 may further include monitoring a setup user interface window generated by the first application and presented via at least one output device. Method 500 may further include determining an application privacy policy setting consented to by a user of the electronic device based on content of the setup user interface window and at least one user input received via the at least one input device to the setup user interface window. Method 500 may further include comparing the application privacy policy setting selected by the user with the device privacy policy settings. In response to determining that the application privacy policy setting violates the device privacy policy settings, method 500 may further include generating and presenting via the at least one output device an alert indicating a violation of device privacy policy settings.

In one or more embodiments, the privacy policy settings include regulatory privacy settings that constrain operation of the first application. In response to detecting the action by the first application to transmit the selected data via the communications subsystem to the network entity, method 500 may further include determining a geographic location of the electronic device. Method 500 may further include identifying the regulatory privacy settings associated with the geographic location and applicable to the data. In response to determining that transmitting the data would violate the regulatory privacy settings, method 500 may further include generating and presenting, via at least one output device, an alert indicating a violation of the regulatory privacy setting. In one or more embodiments, in response to determining that transmitting the data would violate the privacy policy settings, method 500 may further include at least partially blocking the action by altering the data to remove or mask restricted portions of the selected data to avoid violating the privacy policy settings.

With reference to FIG. 6, method 600 may include monitoring a setup user interface window generated by the first application and presented via at least one output device (block 602). Method 600 may include determining an application privacy policy setting consented to by a user of the electronic device based on content of the setup user interface window and at least one user input received via the at least one input device to the setup user interface window (block 604). Method 600 may include comparing the application privacy policy setting selected by the user with the device privacy policy settings (block 606). Method 600 may include determining whether the application privacy policy setting violates the device privacy policy settings (decision block 608). In response to determining that the application privacy policy setting does not violate the device privacy policy settings, method 600 includes enabling a transmission of the data (block 610). Then method 600 ends. In response to determining that the application privacy policy setting violates the device privacy policy settings, method 600 may include generating and presenting via the at least one output device an alert indicating a violation of device privacy policy settings (block 612). Then method 600 ends.

With reference to FIG. 7, method 700 may include determining a geographic location of the electronic device (block 702). Method 700 may include identifying regulatory privacy settings associated with the geographic location and applicable to the data to constrain operation of the first application (block 704). Method 700 may include monitoring for an action (e.g., requesting, storing, or transmitting private data) by the first application that is constrained by a regulatory privacy policy of the regulatory privacy settings (block 706). Method 700 may include determining whether an action is detected that is constrained by the regulatory privacy policy (decision block 708). in response to detecting the action by the first application that is constrained by the regulatory privacy settings, method 700 may include generating and presenting via at least one output device an alert indicating a violation of the regulatory privacy setting (block 710). Then method 700 ends. In response to detecting the action by the first application that is not constrained by the regulatory privacy settings, method 700 includes enabling a transmission of the data associated with that action (block 712). Then method 700 ends.

According to aspects of the present disclosure, the electronic device 100 (FIG. 1A), method 500 (FIG. 5), method 600 (FIG. 6), method 700 (FIG. 7), and computer program product, such as RSD 145 (FIG. 1A), provide techniques for ensuring that user private data is handled (e.g., received, processed, collected, and transmitted) by electronic device in compliance with established privacy policy settings by monitoring applications executed by processor(s) of the electronic device. Applications that do not properly comply with privacy policies are detected. In response, electronic device 100 mitigates by blocking or masking private data being collected and/or transmitted either automatically or by presenting a notification to prompt a manual action.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms "a", "an" and "the" are intended to include the plural forms as well, unless the context clearly indicates otherwise. It will be further understood that the terms "comprise" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a memory comprising (i) one or more applications comprising a first application; and (ii) a privacy policy settings corresponding to the one or more applications;
a communications subsystem that links the electronic device to a network entity associated with the first application; and
a processor communicatively coupled to the memory and the communications subsystem, and which is configured to cause the electronic device to:
in response to detecting an action by the first application to transmit selected data via the communications subsystem to the network entity:
identify a privacy policy applicable to the data, based on the privacy policy settings; and
in response to determining that transmitting the data would violate the privacy policy, at least partially block a transmission of the data.

2. The electronic device of claim 1, further comprising an artificial intelligence (AI) engine trained to identify private data, and wherein, in determining that transmitting the data would violate the privacy policy, the processor is configured to cause the electronic device to:
parse, using the AI engine, the selected data to identify permitted data applicable to the privacy policy and restricted data not applicable to the privacy policy.

3. The electronic device of claim 2, wherein the AI engine is trained to identify settings and determine violations of the privacy policy based on natural language processing.

4. The electronic device of claim 1, further comprising at least one output device communicatively coupled to the processor, wherein, in response to determining that transmitting the selected data would violate the privacy policy, the processor is configured to cause the electronic device to:
generate and present, via the at least one output device, an alert indicating a violation of the privacy policy settings.

5. The electronic device of claim 1, wherein the privacy policy comprises device privacy policy settings that constrain operation of the first application.

6. The electronic device of claim 5, further comprising:
at least one input device communicatively coupled to the processor; and
at least one output device communicatively coupled to the processor;
wherein the processor is configured to cause the electronic device to:
monitor a setup user interface window generated by the first application and presented via the at least one output device;
determine an application privacy policy setting consented to by a user of the electronic device based on content of the setup user interface window and at least one user input received via the at least one input device to the setup user interface window;
compare the application privacy policy setting selected by the user with the device privacy policy settings; and
in response to determining that the application privacy policy setting violates the device privacy policy settings, generate and present via the at least one output device an alert indicating a violation of device privacy policy settings.

7. The electronic device of claim 1, wherein the privacy policy settings comprise regulatory privacy settings that constrain operation of the first application, the electronic device further comprising at least one output device communicatively coupled to the processor, and the processor is configured to cause the electronic device to:
in response to detecting the action by the first application to transmit the selected data via the communications subsystem to the network entity:
determine a geographic location of the electronic device;
identify the regulatory privacy settings associated with the geographic location and applicable to the data; and
in response to determining that transmitting the data would violate the regulatory privacy settings, generate and present via the at least one output device an alert indicating a violation of the regulatory privacy setting.

8. The electronic device of claim 1, further comprising at least one output device communicatively coupled to the processor, wherein the processor is configured to cause the electronic device to:
in response to determining that transmitting the data would violate the privacy policy settings, at least partially block the action by altering the data to remove or mask restricted portions of the selected data to avoid violating the privacy policy settings.

9. A method comprising:
in response to detecting an action by a first application to transmit selected data via a communications subsystem of an electronic device to a network entity:
identifying a privacy policy applicable to the data, based on privacy policy settings; and
in response to determining that transmitting the data would violate the privacy policy, at least partially blocking a transmission of the data.

10. The method of claim 9, wherein determining that transmitting the data would violate the privacy policy further comprises:
parsing, using an artificial intelligence (AI) engine trained to identify private data, the selected data to identify permitted data applicable to the privacy policy and restricted data not applicable to the privacy policy.

11. The method of claim 10, wherein the AI engine is trained to identify settings and determine violations of the privacy policy based on natural language processing.

12. The method of claim 9, further comprising:
in response to determining that transmitting the selected data would violate the privacy policy:
generating and presenting, via at least one output device, an alert indicating a violation of the privacy policy settings.

13. The method of claim 9, wherein the privacy policy comprises device privacy policy settings that constrain operation of the first application.

14. The method of claim 13, further comprising:
monitoring a setup user interface window generated by the first application and presented via at least one output device;
determining an application privacy policy setting consented to by a user of the electronic device based on content of the setup user interface window and at least one user input received via the at least one input device to the setup user interface window;
comparing the application privacy policy setting selected by the user with the device privacy policy settings; and
in response to determining that the application privacy policy setting violates the device privacy policy settings, generating and presenting via the at least one output device an alert indicating a violation of device privacy policy settings.

15. The method of claim 9, wherein the privacy policy settings comprise regulatory privacy settings that constrain operation of the first application, and the method further comprises:
in response to detecting the action by the first application to transmit the selected data via the communications subsystem to the network entity:
determining a geographic location of the electronic device;
identifying the regulatory privacy settings associated with the geographic location and applicable to the data; and
in response to determining that transmitting the data would violate the regulatory privacy settings, generating and presenting via at least one output device an alert indicating a violation of the regulatory privacy setting.

16. The method of claim 9, further comprising:
in response to determining that transmitting the data would violate the privacy policy settings, at least partially blocking the action by altering the data to remove or mask restricted portions of the selected data to avoid violating the privacy policy settings.

17. A computer program product comprising:
a computer readable storage device; and
program code on the computer readable storage device that when executed by a processor associated with an electronic device, the program code is configured to cause the electronic device to provide functionality of:
in response to detecting an action by a first application to transmit selected data via a communications subsystem of the electronic device to a network entity:
identifying a privacy policy applicable to the data, based on privacy policy settings; and
in response to determining that transmitting the data would violate the privacy policy, at least partially blocking a transmission of the data.

18. The computer program product of claim 17, wherein the program code is further configured to cause the electronic device to provide functionality of:
in response to determining that transmitting the selected data would violate the privacy policy:
generating and presenting, via at least one output device, an alert indicating a violation of the privacy policy settings.

19. The computer program product of claim 17, wherein the privacy policy comprises device privacy policy settings that constrain operation of the first application, and the program code is further configured to cause the electronic device to provide functionality of:
monitoring a setup user interface window generated by the first application and presented via at least one output device;
determining an application privacy policy setting consented to by a user of the electronic device based on content of the setup user interface window and at least one user input received via the at least one input device to the setup user interface window;
comparing the application privacy policy setting selected by the user with the device privacy policy settings; and
in response to determining that the application privacy policy setting violates the device privacy policy settings, generating and presenting via the at least one output device an alert indicating a violation of device privacy policy settings.

20. The computer program product of claim 17, wherein the program code is further configured to cause the electronic device to provide functionality of:
in response to detecting the action by the first application to transmit the selected data via the communications subsystem to the network entity:
determining a geographic location of the electronic device;
identifying regulatory privacy settings associated with the geographic location and applicable to the data; and
in response to determining that transmitting the data would violate the regulatory privacy settings, generating and presenting via at least one output device an alert indicating a violation of the regulatory privacy setting.
